(19) United States
(12) Patent Application Publication
(10) Pub. No.: US 2024/0393567 A1
(43) Pub. Date: Nov. 28, 2024

(54) OBJECTIVE

(71) Applicant: Evident Corporation, Tatsuno-machi (JP)

(72) Inventor: Koji NAKAGAWA, Kamiina-gun (JP)

(73) Assignee: Evident Corporation, Tatsuno-machi (JP)

(21) Appl. No.: 18/669,580

(22) Filed: May 21, 2024

(30) Foreign Application Priority Data
May 24, 2023 (JP) 2023-085023

(51) Int. Cl. G02B 9/14; G02B 21/02

(52) U.S. Cl. CPC G02B 9/14; G02B 21/02

(57) ABSTRACT

An objective includes a positive first lens group, a negative second lens group, and a positive third lens group including two or more lens components, in which the first, second, and third lens groups are sequentially disposed from an object side. The first lens group includes a meniscus-shaped first lens having positive refractive power, in which the first lens has a concave surface facing an image side, and a meniscus-shaped second lens having positive refractive power, in which the second lens has a concave surface facing the image side. The second lens group includes two or more positive lenses and one or more negative lenses. The total number of lenses included in the second lens group is seven or more. The objective satisfies the following conditional expressions.

$$1.6 \leq fL / TTL \leq 5 \qquad ( 1 )$$

$$2 \leq ER 1 F / ER 2 F \qquad ( 2 )$$

$$1.29 \leq ER 3 F / ER 2 R \qquad ( 3 )$$

### CROSS REFERENCE TO RELATED APPLICATIONS

This application is based upon and claims the benefit of priority from prior Japanese Patent Application No. 2023-085023, filed May 24, 2023, the entire contents of which are incorporated herein by this reference.

### BACKGROUND OF THE INVENTION

### Field of the Invention

The disclosure of the present specification relates to an objective.

### Description of the Related Art

Recently, in the field of microscopes, microscope devices that achieve both a wide field of view and high resolution and that are capable of performing observation and image acquisition have become mainstream. In particular, in the case of acquiring an image of a wide range of a specimen using an ultra-low magnification objective such as 1 time or 1.25 times, uniform image quality is required from the center of the wide range to the periphery thereof. However, it is not easy to satisfy such a requirement.

A technique related to an objective capable of observing a wide range of a specimen is described, for example, in JP H7-306364 A, JP 2000-249927 A, and JP 2009-294518 A.

### SUMMARY OF THE INVENTION

An objective according to one aspect of the present invention includes a first lens group having positive refractive power, a second lens group having negative refractive power, and a third lens group having the positive refractive power and including two or more lens components, in which the first lens group, the second lens group, and the third lens group are sequentially disposed from an object side. The first lens group includes a meniscus-shaped first lens having the positive refractive power, in which the first lens has a concave surface facing an image side, and a meniscus-shaped second lens having the positive refractive power, in which the second lens has a concave surface facing the image side. In the second lens group, the total number of lenses included in the second lens group including two or more positive lenses and one or more negative lenses is seven or more. The objective satisfies the following conditional expressions.

$$1.6 \leq fL / TTL \leq 5 \qquad ( 1 )$$

$$2 \leq ER 1 F / ER 2 F \qquad ( 2 )$$

$$1.29 \leq ER 3 F / ER 2 R \qquad ( 3 )$$

A surface of the second lens group, the surface being situated closest to the object side, is, among surfaces having an effective radius of ER1F/2 or less of the objective, a surface situated closest to the object side, and a surface of the third lens group, the surface being situated closest to the object side, is, among the surfaces having an effective radius of 1.29×ER2R or more of the objective, a surface situated closest to the object side.

Herein, fL is a focal length of the objective. TTL is a distance on an optical axis from a surface of the objective, the surface being situated closest to the object side, to a surface of the objective, the surface being situated closest to the image side. ER1F is an effective radius of the surface of the objective, the surface being situated closest to the object side. ER2F is an effective radius of the surface of the second lens group, the surface being situated closest to the object side. ER2R is an effective radius of a surface of the second lens group, the surface being situated closest to the image side. ER3F is an effective radius of the surface of the third lens group, the surface being situated closest to the object side.

### BRIEF DESCRIPTION OF THE DRAWINGS

The present invention will be more apparent from the following detailed description when the accompanying drawings are referenced.

FIG. 1 is a cross-sectional view of an objective according to a first embodiment of the present invention;

FIG. 2 is a cross-sectional view of a tube lens;

FIGS. 3A to 3D are diagrams of aberrations in an optical system including the objective according to a first embodiment and the tube lens;

FIG. 4 is a cross-sectional view of an objective according to a second embodiment of the present invention;

FIGS. 5A to 5D are diagrams of aberrations in an optical system including the objective according to a second embodiment and the tube lens;

FIG. 6 is a cross-sectional view of an objective according to a third embodiment of the present invention;

FIGS. 7A to 7D are diagrams of aberrations in an optical system including the objective according to a third embodiment and the tube lens;

FIG. 8 is a cross-sectional view of an objective according to a fourth embodiment of the present invention; and

FIGS. 9A to 9D are diagrams of aberrations in an optical system including the objective according to a fourth embodiment and the tube lens.

### DESCRIPTION OF THE EMBODIMENTS

In the objectives disclosed in JP H7-306364 A, JP 2000-249927 A, and JP 2009-294518 A, there is room for improvement in aberration correction from the center to the periphery, particularly correction of off-axis aberration such as field curvature. For this reason, it is expected to further improve the uniformity of image quality in a case where an image is acquired by an objective having a wide field of view, particularly an ultra-low magnification objective such as 1 time or 1.25 times.

An objective according to an embodiment of the present application will be described. The objective according to the present embodiment (hereinafter, simply referred to as an objective) is an infinity-corrected microscope objective used in combination with a tube lens.

The objective includes, in order from the object side, a first lens group having positive refractive power, a second lens group having negative refractive power, and a third lens group having the positive refractive power. The third lens group includes two or more lens components.

In the present specification, the lens component refers to a lens block in which only two surfaces that are a surface on the object side and a surface on an image side, from among lens surfaces through which a light ray from an object point passes, have contact with air regardless of whether the lens is a single lens or a cemented lens. In other words, one single lens is one lens component, and one cemented lens is also one lens component. On the other hand, a plurality of single lenses and a plurality of cemented lenses arranged via air are not referred to as one lens component herein.

The size of an optical system constituting the microscope objective is practically limited, and is required to fall within a predetermined size. In order to achieve an ultra-low magnification objective having a wide field of view by such an optical system having a predetermined size, it is desirable to employ a telephoto-type optical system capable of increasing a focal length without increasing the size. In order to realize the telephoto-type optical system, it is desirable to dispose a lens group having positive refractive power on the object side, and to dispose, in the rear thereof, a lens group having negative refractive power. Furthermore, in order to realize an infinity-corrected objective, it is desirable to dispose the lens group having the positive refractive power in a lens group situated closest to the image side in order to change divergent light, which has been emitted from the lens group having the negative refractive power, to parallel light. In consideration of the foregoing, it is desirable to adopt the above-described power arrangement for the three lens groups constituting the objective.

In addition, in order to achieve characteristics of the telephoto-type optical system, that is, characteristics of making a total length of the optical system shorter than a focal length (hereinafter, referred to as a telephoto property), the first lens group is required to have large positive refractive power. Therefore, it is desirable to arrange two or more positive lenses in the first lens group, and it is desirable to have a meniscus shape with a concave surface facing the image surface side in order to suppress occurrence of aberration. In other words, the first lens group desirably includes a meniscus-shaped lens (a first lens) having positive refractive power with a concave surface facing the image side and a meniscus-shaped lens (a second lens) having positive refractive power with a concave surface facing the image side. The meniscus-shaped lens may be a single lens (single meniscus lens) or a cemented lens. In the case of the cemented lens, both a surface situated closest to the object side and a surface situated closest to the image side may be formed as concave surfaces facing the image side.

Furthermore, in order to achieve the telephoto property, the second lens group is required to have large negative refractive power. However, if the large negative refractive power is imparted to the second lens group, the Petzval sum tends to be excessively corrected, and, as a result, it becomes difficult to satisfactorily correct field curvature in the whole objective. To solve such a technical problem, two or more positive lenses are included in the second lens group having negative refractive power so as to avoid excessive correction of the Petzval sum to the negative side, and the number of lenses is increased so as to correct not only field curvature (Petzval sum) but also various aberrations (lateral chromatic aberration, axial chromatic aberration, spherical aberration, coma aberration, and the like). Specifically, the second lens group may include seven or more lenses, and the second lens group may include at least two or more positive lenses. That is, the second lens group having the negative refractive power includes two or more positive lenses and one or more negative lenses, and the number of lenses included in the second lens group is seven or more.

In the third lens group, an on-axis light ray and an off-axis light ray have substantially the same light flux width. Therefore, the third lens group desirably plays a role of simultaneously correcting spherical aberration and off-axis coma aberration. It is desirable to dispose two or more lens components in the third lens group because aberration correction cannot be sufficiently performed only with one lens component and the above-described role cannot be sufficiently performed. That is, the third lens group includes two or more lens components.

The objective built as described above is configured to satisfy following conditional expressions (1) to (3).

$$1.6 \leq fL / TTL \leq 5 \qquad ( 1 )$$

$$2 \leq ER 1 F / ER 2 F \qquad ( 2 )$$

$$1.29 \leq ER 3 F / ER 2 R \qquad ( 3 )$$

Herein, fL is a focal length of the objective. TTL is a distance on an optical axis from a surface of the objective that is situated closest to the object side to a surface of the objective that is situated closest to the image side. ER1F is an effective radius of the surface of the objective that is situated closest to the object side. ER2F is an effective radius of the surface of the second lens group that is situated closest to the object side. ER2R is an effective radius of the surface of the second lens group that is situated closest to the image side. ER3F is an effective radius of the surface of the third lens group that is situated closest to the object side.

Furthermore, the surface of the second lens group that is situated closest to the object side is, among the surfaces having an effective radius of ER1F/2 or less of the objective, a surface that is situated closest to the object side. Furthermore, the surface of the third lens group that is situated closest to the object side is, among the surfaces having an effective radius of 1.29×ER2R or more of the objective, a surface that is situated closest to the object side. A boundary between the first lens group and the second lens group and a boundary between the second lens group and the third lens group can be determined by these definitions.

The conditional expression (1) is a conditional expression for ensuring a wide field of view. When the conditional expression is satisfied, a wide field of view can be realized while the objective is built compactly.

In a case in which fL/TTL is lower than a lower limit value (1.6), when the objective is built by an allowed total length, the focal length of the objective becomes excessively short. As a result, it becomes difficult to ensure a sufficiently wide field of view. When fL/TTL exceeds an upper limit value (5), the focal length becomes too large with respect to the total length. As a result, although the field of view becomes wide, an off-axis principal light ray also becomes high, field curvature aberration mainly occurs largely, and the correction becomes difficult.

The conditional expression (2) is a conditional expression for limiting a light ray height of light incident on the second lens group. In combination with a condition that the surface of the second lens group that is situated closest to the object side is, among the surfaces having an effective radius of ER1F/2 or less of the objective, a surface that is situated closest to the object side (a first definition of the boundary), the conditional expression (2) also functions as a conditional expression for defining the position of the second lens group.

When the conditional expression (2) is satisfied under the first definition of the boundary, an off-axis light flux can be incident on the second lens group having the negative refractive power at a position not too far away from the object surface and a position having a relatively low light ray height. At such a position, since an on-axis light flux and the off-axis light flux are separated from each other, it is possible to correct field curvature while avoiding adverse effects on other aberrations (mainly spherical aberration and axial chromatic aberration) and to realize a telephoto-type optical system.

The conditional expression (3) is a conditional expression for limiting a light ray height of light incident on the third lens group. In combination with a condition that the surface of the third lens group that is situated closest to the object side is, among the surfaces having an effective radius of 1.29×ER2R or more of the objective, a surface that is situated closest to the object side d (a second definition of the boundary), the conditional expression (3) also functions as a conditional expression for defining the position of the third lens group.

When the conditional expression (3) is satisfied under the second definition of the boundary, the light flux sufficiently spread by the negative refractive power of the second lens group can be incident on the third lens group having the positive refractive power. This makes it possible to realize an infinity-corrected optical system while satisfactorily correcting spherical aberration and coma aberration.

According to the objective configured in the above-described manner, aberrations from the center to the periphery of a wide field of view can be satisfactorily corrected.

It is noted that the objective may be configured to satisfy a following conditional expression (1-1) instead of or in addition to the conditional expression (1). Further, the objective may be configured to satisfy a following conditional expression (2-1) instead of or in addition to the conditional expression (2). Additionally, the objective may be configured to satisfy a following conditional expression (3-1) instead of or in addition to the conditional expression (3).

$$3.12 \leq fL / TTL \leq 3.92 \qquad ( 1 - 1 )$$

$$2.29 \leq ER 1 F / ER 2 F \leq 3.31 \qquad ( 2 - 1 )$$

$$1.29 \leq ER 3 F / ER 2 R \leq 1.56 \qquad ( 3 - 1 )$$

A desirable configuration of the objective will be described below.

The objective desirably satisfies a following conditional expression (4). Here, f2 is a focal length of the second lens group.

$$0.005 \leq \vert f 2 / fL \vert \leq 0 \text{.03} \qquad ( 4 )$$

The conditional expression (4) is a conditional expression that defines the refractive power of the second lens group. When the conditional expression (4) is satisfied, field curvature can be satisfactorily corrected while the optical system is built more compactly. If |f2/fL| is lower than a lower limit value, the negative refractive power of the second lens group becomes excessively large, and, therefore, field curvature is excessively corrected. On the other hand, if |f2/fL| is higher than an upper limit value, the negative refractive power of the second lens group becomes excessively small, and, therefore, field curvature is insufficiently corrected. As a result, in order to satisfactorily perform the aberration correction, it is necessary to compensate for the insufficient correction with components other than the second lens group, and thus, the overall size of the objective needs to be increased in order to cope with the above-described problem.

It is noted that the objective may be configured to satisfy a following conditional expression (4-1) instead of or in addition to the conditional expression (4).

$$0.006 \leq \vert f 2 / fL \vert \leq 0.0 \; 15 \qquad ( 4 - 1 )$$

The second lens group desirably includes a plurality of cemented lenses in order to effectively correct the lateral chromatic aberration and the axial chromatic aberration in the second lens group. In particular, it is desirable that three or more cemented lens components are included, and the objective satisfies following conditional expressions (5) and (6).

$$35 \leq v 2 p \qquad ( 5 )$$

$$50 \geq v 2 m \qquad ( 6 )$$

It is noted that v2p is the highest Abbe number with respect to the d-line among the positive lenses constituting the cemented lens components included in the second lens group. It is noted that v2m is the lowest Abbe number with respect to the d-line among the negative lenses constituting the cemented lens components included in the second lens group.

The conditional expressions (5) and (6) are conditional expressions for effectively correcting the chromatic aberration. When the objective (more specifically, the cemented lens component in the second lens group) satisfies the conditional expressions (5) and (6), an achromatization effect using the positive lens with low dispersion and the negative lens with high dispersion is exhibited, so that the lateral chromatic aberration and the axial chromatic aberration can be satisfactorily corrected. It is noted that, even if v2p falls below a lower limit value (35) or even if v2m exceeds an upper limit value (50), chromatic aberration correction is insufficient.

The objective desirably satisfies following conditional expressions (7) and (8).

$$1.6 \geq n 2 p \qquad ( 7 )$$

$$1.85 \leq n 2 m \qquad ( 8 )$$

Here, n2p is a lowest refractive index with respect to the e-line among the positive lenses included in the second lens group. n2m is a highest refractive index with respect to the e-line among the negative lenses included in the second lens group.

The conditional expressions (7) and (8) are conditional expressions for satisfactorily correcting the field curvature. Since the second lens group has large negative refractive power, the Petzval sum tends to be biased negatively. By satisfying the conditional expressions (7) and (8), the positive component included in the Petzval sum increases and the negative component decreases. This makes it possible to bring the Petzval sum close to zero to more satisfactorily correct the field curvature. It is noted that, even if n2p exceeds an upper limit value (1.6) or n2m falls below a lower limit value (1.85), field curvature correction is insufficient.

The objective desirably satisfies a following conditional expression (9).

$$0.74 \leq ofb / OTTL \leq 1.41 \qquad ( 9 )$$

Here, ofb is a distance on the optical axis from the object surface to the rear focal position of the objective. OTTL is a distance on the optical axis from the object surface to the surface of the objective that is situated closest to the image side.

The conditional expression (9) is a conditional expression for ensuring telecentricity on the object side. When the conditional expression (9) is satisfied, the objective can be configured as an optical system that is telecentric on the object side and is suitable as a microscope objective.

Even if ofb/OTTL is lower than a lower limit value (0.74) or ofb/OTTL is higher than an upper limit value (1.41), telecentricity on the object side deteriorates. In the object-side telecentric optical system in which entrance pupil is at infinity, the position of exit pupil and the rear focal position match each other. In the object-side telecentric optical system with a low-magnification objective having entrance pupil at infinity, a pupil plane is usually designed to be positioned in the vicinity of the lens surface that is situated closest to the image side. Therefore, high object-side telecentricity can be obtained when the lens surface that is situated closest to the image side is provided at a position that is not excessively distant from the rear focal position.

It is noted that the objective may be configured to satisfy a following conditional expression (9-1) instead of or in addition to the conditional expression (9).

$$0.77 \leq ofb / OTTL \leq 1.38 \qquad ( 9 - 1 )$$

Hereinafter, embodiments of the objective described above will be described in detail.

### First Embodiment

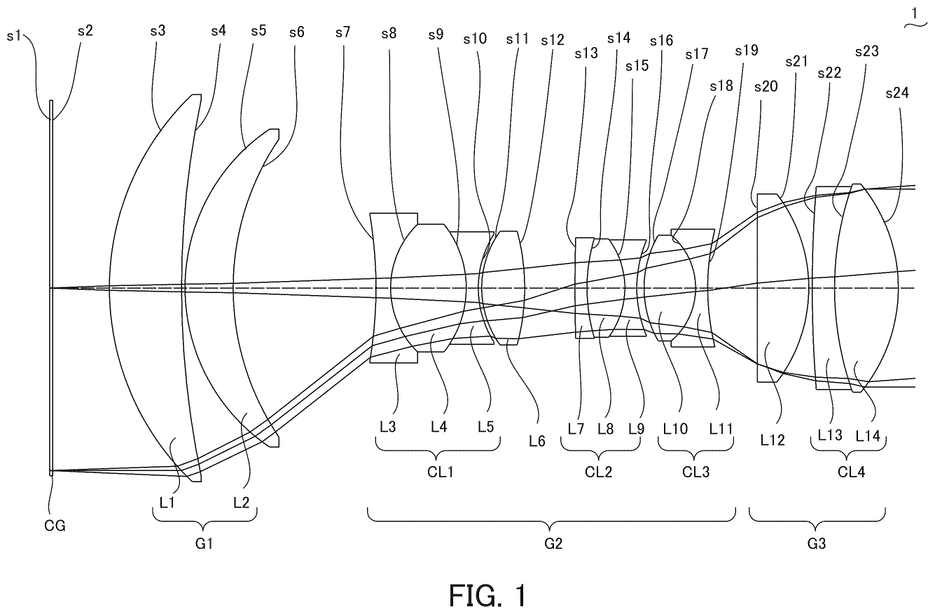

FIG. 1 is a cross-sectional view of an objective 1 according to the present embodiment. The objective 1 is a microscope objective and includes a first lens group G1 having positive refractive power, a second lens group G2 having negative refractive power, and a third lens group G3 having positive refractive power and including two lens components.

The first lens group G1 includes, in order from the object side, a lens L1 serving as a meniscus lens and having a concave surface facing an image side and a lens L2 serving as a meniscus lens and having a concave surface facing the image side. Each of the lens L1 and the lens L2 is a positive lens having positive refractive power.

The second lens group G2 includes a cemented lens CL1, a lens L6 serving as a biconvex lens, a cemented lens CL2, and a cemented lens CL3. The cemented lens CL1 is a three-piece cemented lens including, in order from the object side, a lens L3 serving as a biconcave lens, a lens L4 serving as a biconvex lens, and a lens L5 serving as a biconcave lens. The cemented lens CL2 is a three-piece cemented lens including, in order from the object side, a lens L7 serving as a meniscus lens and having a concave surface facing the image side, a lens L8 serving as a biconvex lens, and a lens L9 serving as a biconcave lens. The cemented lens CL3 is a two-piece cemented lens including, in order from the object side, a lens L10 serving as a biconvex lens and a lens L11 serving as a biconcave lens.

The second lens group G2 includes two or more positive lenses (the lens L4, the lens L6, and the like) and one or more negative lenses (the lens L3 and the like). The total number of lenses included in the second lens group is nine and is seven or more.

The third lens group G3 includes, in order from the object side, a lens L12 serving as a plano-convex lens and having a convex surface facing the image side and a cemented lens CL4. The cemented lens CL4 is a two-piece cemented lens including, in order from the object side, a lens L13 serving as a meniscus lens and having a concave surface facing the image side and a lens L14 serving as a biconvex lens.

Various pieces of data of the objective 1 are described as follows. It is noted that fL, f1, f2, and f3 are the focal length of the objective, the focal length of the first lens group G1, the focal length of the second lens group G2, and the focal length of the third lens group G3, respectively. The other parameters are as described above.
fL=143.55 mm, f1=18.96 mm, f2=−1.45 mm, f3=10.89 mm
TTL=45.90 mm, ER1F=10.94 mm, ER2F=4.05 mm, ER2R=3.118 mm, ER3F=4.687 mm, v2p=45.79, v2m=40.76, n2p=1.59911, n2m=1.88815, ofb=43.42 mm, OTTL=49.37 mm

Lens data of the objective 1 is described as follows. It is noted that INF in the lens data represents infinity (o).

Objective Lens 1

| s | r | d | ne | νd | er |
|---|---|---|---|---|---|
| s1 | INF | 0.17 | 1.52626 | 54.41 | 10.60 |
| s2 | INF | 3.30 | | | 10.60 |
| s3 | 15.529 | 4.20 | 1.73234 | 54.68 | 10.94 |
| s4 | 53.049 | 0.20 | | | 10.66 |
| s5 | 11.120 | 2.80 | 1.57098 | 71.30 | 8.93 |
| s6 | 15.395 | 8.31 | | | 8.36 |
| s7 | −25.586 | 0.85 | 1.82017 | 46.62 | 4.05 |
| s8 | 5.173 | 4.40 | 1.59911 | 39.24 | 3.40 |
| s9 | −5.946 | 0.70 | 1.88815 | 40.76 | 2.97 |
| s10 | 5.852 | 0.20 | | | 2.83 |
| s11 | 5.657 | 2.50 | 1.55098 | 45.79 | 2.98 |
| s12 | −12.514 | 2.92 | | | 3.00 |
| s13 | 108.030 | 0.70 | 1.75844 | 52.32 | 2.63 |
| s14 | 10.011 | 2.20 | 1.67765 | 32.10 | 2.55 |
| s15 | −4.797 | 0.70 | 1.88815 | 40.76 | 2.48 |
| s16 | 7.185 | 0.42 | | | 2.49 |
| s17 | 6.132 | 3.00 | 1.59667 | 35.31 | 2.74 |
| s18 | −4.033 | 0.70 | 1.88815 | 40.76 | 2.78 |
| s19 | 14.011 | 2.88 | | | 3.12 |
| s20 | INF | 3.00 | 1.59732 | 67.74 | 4.69 |
| s21 | −8.960 | 0.20 | | | 5.16 |
| s22 | 72.531 | 1.30 | 1.89760 | 37.13 | 5.50 |
| s23 | 17.982 | 3.71 | 1.43985 | 94.93 | 5.59 |
| s24 | −9.471 | 56.62 | | | 5.75 |

Herein, s represents a surface number, r represents a curvature radius (mm), d represents a surface spacing (mm), ne represents a refractive index with respect to an e-line, vd represents the Abbe number with respect to a d-line, and er represents an effective radius (mm). These symbols are the same in the following embodiments. It is noted that surfaces represented by surface numbers s1 and s2 are a sample-side surface and a surface on the objective 1 side of a cover glass CG, respectively. Surfaces represented by surface numbers s3 and s24 are a lens surface of the objective 1 that is situated closest to the object side and a lens surface of the objective 1 that is situated closest to the image side, respectively. For example, a surface spacing d1 represents a distance on the optical axis from the surface represented by the surface number s1 to the surface represented by the surface number s2. It is noted that a surface spacing d24 represents a distance (56.62 mm) on the optical axis from the surface represented by the surface number s24 to the surface of the tube lens that is situated closest to the object side.

The objective 1 satisfies conditional expressions (1) to (9) as described below.

$$fL / TTL = 3.128 \qquad ( 1 )$$

$$ER 1 F / ER 2 F = 2.70 \qquad ( 2 )$$

$$ER 3 F / ER 2 R = 1.503 \qquad ( 3 )$$

$$\vert f 2 / fL \vert = 0 \text{.0101} \qquad ( 4 )$$

$$v 2 p = 45.79 \qquad ( 5 )$$

$$v 2 m = 40.76 \qquad ( 6 )$$

$$n 2 p = 1.59911 \qquad ( 7 )$$

$$n 2 m = 1.88815 \qquad ( 8 )$$

$$ofb / OTTL = 0.879 \qquad ( 9 )$$

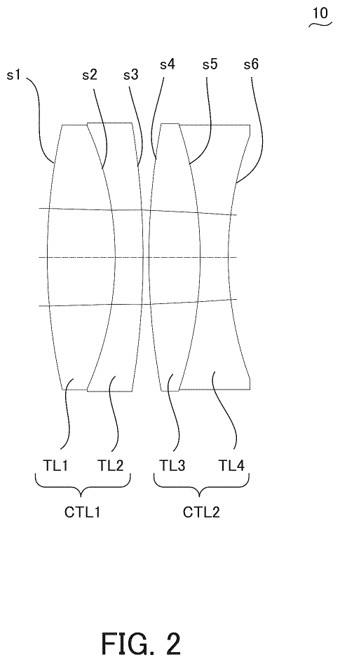

FIG. 2 is a cross-sectional view of a tube lens 10 used in combination with the objective 1. The tube lens 10 is a microscope tube lens that forms an image of an object in combination with an infinity-corrected objective. The tube lens 10 includes a cemented lens CTL1 and a cemented lens CTL2. The cemented lens CTL1 includes a lens TL1 serving as a biconvex lens and a lens TL2 serving as a meniscus lens and having a concave surface facing the object side. The cemented lens CTL2 includes a lens TL3 serving as a biconvex lens and a lens TL4 serving as a biconcave lens. The tube lens 10 is disposed such that a distance on the optical axis from the lens surface of the objective 1 (surface number s24) situated closest to the image side to the lens surface of the tube lens 10 (surface number s1) situated closest to the object side is 56.62 mm. It is noted that the focal length of the tube lens 10 is 180 mm.

Lens data of the tube lens 10 is described as follows.

Tube Lens 10

| s | r | d | ne | νd |
|---|---|---|---|---|
| s1 | 69.950 | 8.00 | 1.48915 | 70.23 |
| s2 | −38.132 | 3.30 | 1.83945 | 42.71 |
| s3 | −95.720 | 0.67 | | |
| s4 | 85.872 | 6.05 | 1.83932 | 37.16 |
| s5 | −50.111 | 3.30 | 1.65803 | 39.68 |
| s6 | 41.656 | | | |

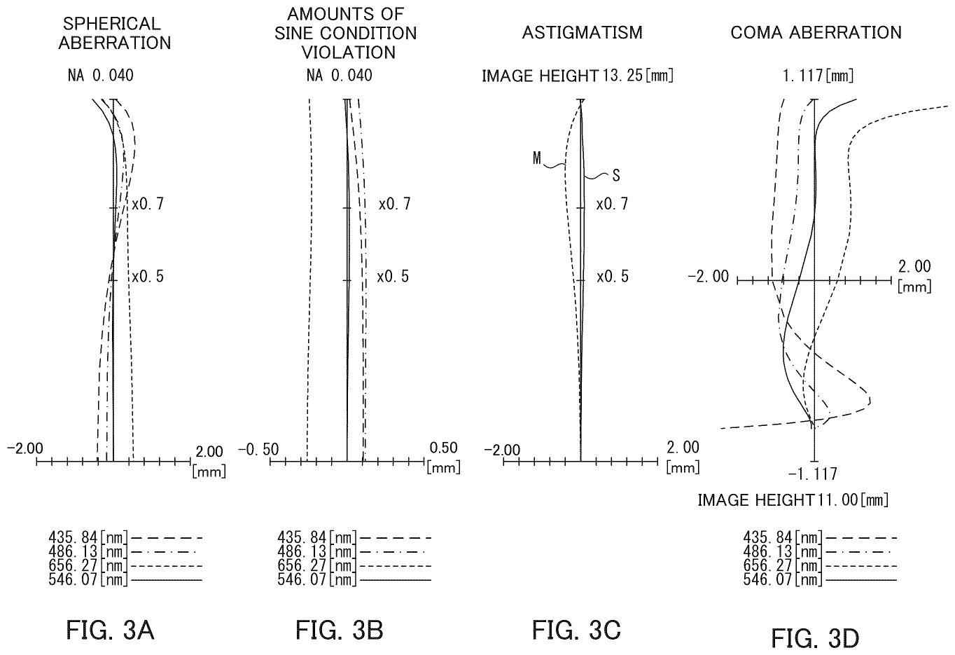

FIGS. 3A to 3D are aberration diagrams of an optical system including the objective 1 and the tube lens 10, and illustrate aberrations in the image plane obtained by performing light ray tracing from the object side to the image side. FIG. 3A is a diagram of spherical aberrations. FIG. 3B is a diagram illustrating the amounts of sine condition violation. FIG. 3C is an astigmatism diagram. FIG. 3D is a diagram illustrating coma aberrations at an image height ratio of 0.83 (image height of 11.0 mm). It is noted that in the drawing, “M” indicates a meridional component and “S” indicates a sagittal component. As illustrated in FIGS. 3A to 3D, in the present embodiment, the aberration is satisfactorily corrected over a wide field of view.

### Second Embodiment

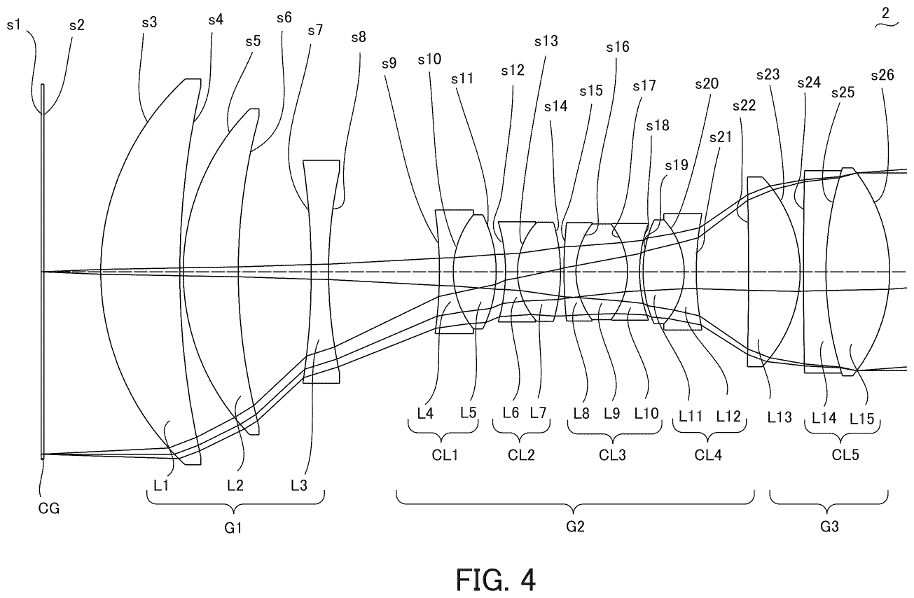

FIG. 4 is a cross-sectional view of an objective 2 according to the present embodiment. The objective 2 is a microscope objective and includes a first lens group G1 having positive refractive power, a second lens group G2 having negative refractive power, and a third lens group G3 having positive refractive power and including two lens components.

The first lens group G1 includes, in order from the object side, a lens L1 serving as a meniscus lens and having a concave surface facing the image side, a lens L2 serving as a meniscus lens and having a concave surface facing the image side, and a lens L3 serving as a biconcave lens. Each of the lens L1 and the lens L2 is a positive lens having positive refractive power.

The second lens group G2 includes a cemented lens CL1, a cemented lens CL2, a cemented lens CL3, and a cemented lens CL4. The cemented lens CL1 is a two-piece cemented lens including, in order from the object side, a lens L4 serving as a biconcave lens and a lens L5 serving as a biconvex lens. The cemented lens CL2 is a two-piece cemented lens including, in order from the object side, a lens L6 serving as a biconcave lens and a lens L7 serving as a biconvex lens. The cemented lens CL3 is a three-piece cemented lens including, in order from the object side, a lens L8 serving as a meniscus lens and having a concave surface facing the image side, a lens L9 serving as a biconvex lens, and a lens L10 serving as a biconcave lens. The cemented lens CL4 is a two-piece cemented lens including, in order from the object side, a lens L11 serving as a biconvex lens and a lens L12 serving as a biconcave lens.

The second lens group G2 includes two or more positive lenses (the lens L5, the lens L7, and the like) and one or more negative lenses (the lens L4 and the like). The total number of lenses included in the second lens group is nine and is seven or more.

The third lens group G3 includes, in order from the object side, a lens L13 serving as a meniscus lens and having a concave surface facing the object side and a cemented lens CL5. The cemented lens CL5 is a two-piece cemented lens including, in order from the object side, a lens L14 serving as a meniscus lens and having a concave surface facing the image side and a lens L15 serving as a biconvex lens.

Various pieces of data of the objective 2 are described as follows.
fL=143.34 mm, f1=26.84 mm, f2=−2.16 mm, f3=11.13 mm
TTL=45.90 mm, ER1F=10.91 mm, ER2F=3.29 mm, ER2R=3.088 mm, ER3F=4.808 mm, v2p=45.79, v2m=40.76, n2p=1.55098, n2m=1.88815, ofb=38.35 mm, OTTL=49.37 mm

Lens data of the objective 2 is described as follows.

Objective Lens 2

| s | r | d | ne | νd | er |
|---|---|---|---|---|---|
| s1 | INF | 0.17 | 1.52626 | 54.41 | 10.60 |
| s2 | INF | 3.30 | | | 10.60 |
| s3 | 15.251 | 4.60 | 1.73234 | 54.68 | 10.91 |
| s4 | 48.192 | 0.20 | | | 10.48 |
| s5 | 13.515 | 3.20 | 1.57098 | 71.30 | 9.17 |
| s6 | 34.281 | 4.25 | | | 8.70 |
| s7 | −43.159 | 1.00 | 1.82017 | 46.62 | 6.18 |
| s8 | 27.376 | 6.45 | | | 5.56 |
| s9 | −25.468 | 0.80 | 1.83945 | 42.74 | 3.29 |
| s10 | 5.269 | 2.50 | 1.59911 | 39.24 | 3.02 |
| s11 | −7.421 | 0.54 | | | 2.96 |
| s12 | −10.116 | 0.70 | 1.88815 | 40.76 | 2.62 |
| s13 | 4.261 | 2.50 | 1.55098 | 45.79 | 2.49 |
| s14 | −10.212 | 0.20 | | | 2.58 |
| s15 | 27.802 | 0.70 | 1.75844 | 52.32 | 2.56 |
| s16 | 4.623 | 3.00 | 1.67765 | 32.10 | 2.48 |
| s17 | −4.483 | 0.70 | 1.88815 | 40.76 | 2.43 |
| s18 | 7.871 | 0.20 | | | 2.51 |
| s19 | 7.401 | 2.40 | 1.59667 | 35.31 | 2.63 |
| s20 | −4.446 | 0.70 | 1.88815 | 40.76 | 2.72 |
| s21 | 17.628 | 3.04 | | | 3.09 |
| s22 | −211.011 | 3.00 | 1.59732 | 67.74 | 4.81 |
| s23 | −7.996 | 0.20 | | | 5.22 |
| s24 | 318.736 | 1.30 | 1.89760 | 37.13 | 5.47 |
| s25 | 19.467 | 3.71 | 1.43985 | 94.93 | 5.58 |
| s26 | −9.571 | 56.62 | | | 5.75 |

The objective 2 satisfies conditional expressions (1) to (9) as described below.

$$fL / TTL = 3.123 \qquad ( 1 )$$

$$ER 1 F / ER 2 F = 3.31 \qquad ( 2 )$$

$$ER 3 F / ER 2 R = 1.557 \qquad ( 3 )$$

$$\vert f 2 / fL \vert = 0.0150 \qquad ( 4 )$$

$$v 2 p = 45.79 \qquad ( 5 )$$

$$v 2 m = 40.76 \qquad ( 6 )$$

$$n 2 p = 1.55098 \qquad ( 7 )$$

$$n 2 m = 1.88815 \qquad ( 8 )$$

$$ofb / OTTL = 0.777 \qquad ( 9 )$$

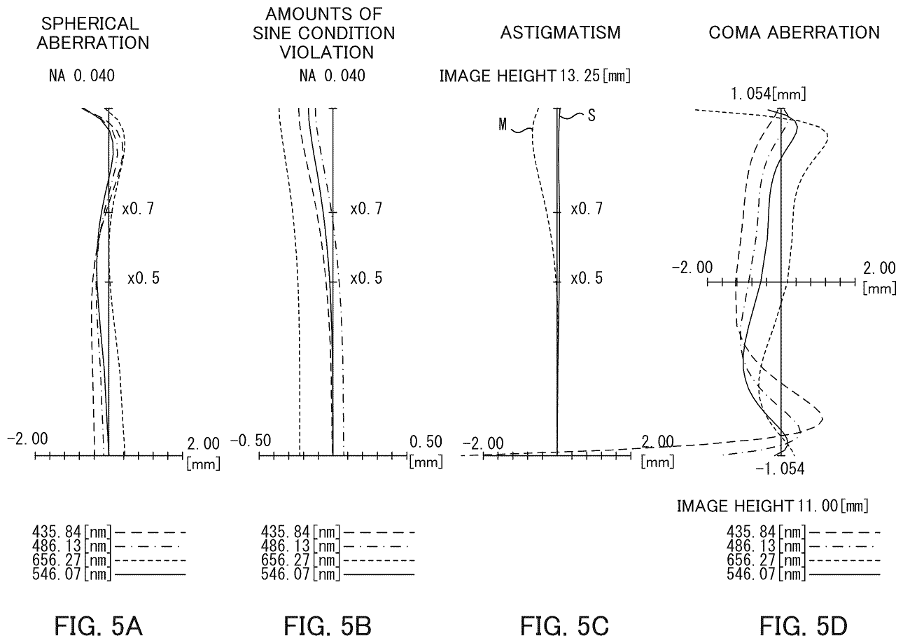

FIGS. 5A to 5D are aberration diagrams of the optical system including the objective 2 and the tube lens 10, and illustrate aberrations in the image plane obtained by performing light ray tracing from the object side to the image side. FIG. 5A is a diagram of spherical aberrations. FIG. 5B is a diagram illustrating the amounts of sine condition violation. FIG. 5C is an astigmatism diagram. FIG. 5D is a diagram illustrating coma aberrations at an image height ratio of 0.83 (image height of 11.0 mm). As illustrated in FIGS. 5A to 5D, in the present embodiment, the aberration is satisfactorily corrected over a wide field of view.

### Third Embodiment

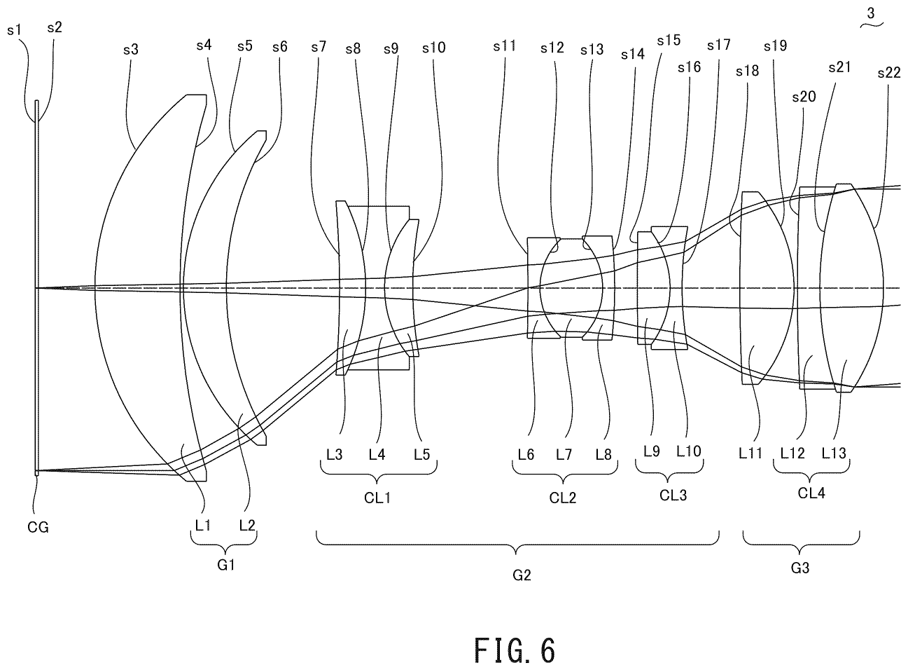

FIG. 6 is a cross-sectional view of an objective 3 according to the present embodiment. The objective 3 is a microscope objective and includes a first lens group G1 having positive refractive power, a second lens group G2 having negative refractive power, and a third lens group G3 having positive refractive power and including two lens components.

The first lens group G1 includes, in order from the object side, a lens L1 serving as a meniscus lens and having a concave surface facing the image side and a lens L2 serving as a meniscus lens and having a concave surface facing the image side. Each of the lens L1 and the lens L2 is a positive lens having positive refractive power.

The second lens group G2 includes a cemented lens CL1, a cemented lens CL2, and a cemented lens CL3. The cemented lens CL1 is a three-piece cemented lens including, in order from the object side, a lens L3 serving as a meniscus lens and having a concave surface facing the object side, a lens L4 serving as a biconcave lens, and a lens L5 serving as a meniscus lens and having a concave surface facing the image side. The cemented lens CL2 is a three-piece cemented lens including, in order from the object side, a lens L6 serving a biconcave lens, a lens L7 serving as a biconvex lens, and a lens L8 serving as a meniscus lens and having a concave surface facing the object side. The cemented lens CL3 is a two-piece cemented lens including, in order from the object side, a lens L9 serving as a biconvex lens and a lens L10 serving as a biconcave lens.

The second lens group G2 includes two or more positive lenses (the lens L7, the lens L9, and the like) and one or more negative lenses (the lens L4 and the like). The total number of lenses included in the second lens group is eight and is seven or more.

The third lens group G3 includes, in order from the object side, a lens L11 serving as a biconvex lens and a cemented lens CL4. The cemented lens CL4 is a two-piece cemented lens including, in order from the object side, a lens L12 serving as a meniscus lens and having a concave surface facing the image side and a lens L13 serving as a biconvex lens.

Various pieces of data of the objective 3 are described as follows.
fL=143.51 mm, f1=18.97 mm, f2=−1.65 mm, f3=12.53 mm
TTL=45.90 mm, ER1F=10.92 mm, ER2F=4.76 mm, ER2R=3.265 mm, ER3F=4.923 mm, v2p=35.31, v2m=40.76, n2p=1.59667, n2m=1.88815, ofb=63.90 mm, OTTL=49.37 mm

Lens data of the objective 3 is described as follows.

Objective Lens 3

| s | r | d | ne | νd | er |
|---|---|---|---|---|---|
| s1 | INF | 0.17 | 1.52626 | 54.41 | 10.60 |
| s2 | INF | 3.30 | | | 10.60 |
| s3 | 14.477 | 4.95 | 1.77621 | 49.60 | 10.92 |
| s4 | 37.628 | 0.20 | | | 10.31 |
| s5 | 11.830 | 2.50 | 1.57098 | 71.30 | 8.83 |
| s6 | 17.120 | 6.59 | | | 8.32 |
| s7 | −60.136 | 1.52 | 1.59667 | 35.31 | 4.76 |
| s8 | −11.346 | 1.10 | 1.88815 | 40.76 | 4.45 |
| s9 | 6.252 | 1.64 | 1.59667 | 35.31 | 3.68 |
| s10 | 21.487 | 6.70 | | | 3.57 |
| s11 | −115.565 | 0.70 | 1.88815 | 40.76 | 2.62 |
| s12 | 3.950 | 3.65 | 1.67765 | 32.10 | 2.51 |
| s13 | −4.037 | 0.70 | 1.88815 | 40.76 | 2.56 |
| s14 | −28.943 | 1.32 | | | 2.72 |
| s15 | 239.720 | 1.90 | 1.59667 | 35.31 | 2.90 |
| s16 | −5.449 | 0.70 | 1.88815 | 40.76 | 2.97 |
| s17 | 19.323 | 3.36 | | | 3.27 |
| s18 | 112.852 | 3.15 | 1.48915 | 70.23 | 4.92 |
| s19 | −8.552 | 0.20 | | | 5.29 |
| s20 | 131.019 | 1.30 | 1.88815 | 40.76 | 5.51 |
| s21 | 19.379 | 3.71 | 1.43985 | 94.93 | 5.58 |
| s22 | −10.600 | 56.62 | | | 5.75 |

The objective 3 satisfies conditional expressions (1) to (9) as described below.

$$fL / TTL = 3.127 \qquad ( 1 )$$

$$ER 1 F / ER 2 F = 2.29 \qquad ( 2 )$$

$$ER 3 F / ER 2 R = 1.5 8 \qquad ( 3 )$$

$$\vert f 2 / fL \vert = 0 \text{.0115} \qquad ( 4 )$$

$$v 2 p = 35.31 \qquad ( 5 )$$

$$v 2 m = 40.76 \qquad ( 6 )$$

$$n 2 p = 1.59667 \qquad ( 7 )$$

$$n 2 m = 1.88815 \qquad ( 8 )$$

$$ofb / OTTL = 1.29 4 \qquad ( 9 )$$

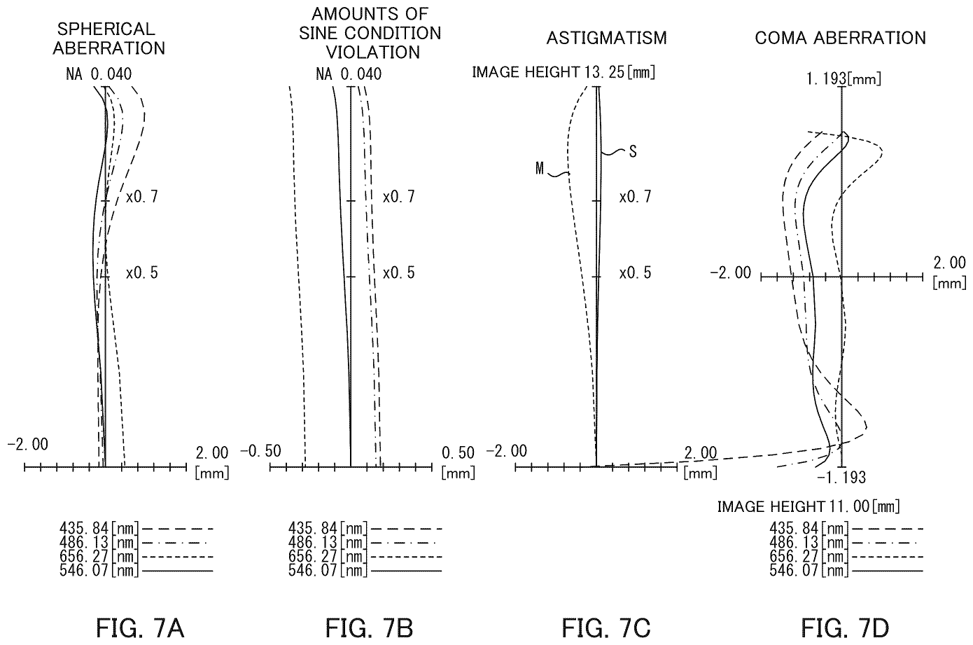

FIGS. 7A to 7D are aberration diagrams of the optical system including the objective 3 and the tube lens 10, and illustrate aberrations in the image plane obtained by performing light ray tracing from the object side to the image side. FIG. 7A is a diagram of spherical aberrations. FIG. 7B is a diagram illustrating the amounts of sine condition violation. FIG. 7C is an astigmatism diagram. FIG. 7D is a diagram illustrating coma aberrations at an image height ratio of 0.83 (image height of 11.0 mm). As illustrated in FIGS. 7A to 7D, in the present embodiment, the aberration is satisfactorily corrected over a wide field of view.

### Fourth Embodiment

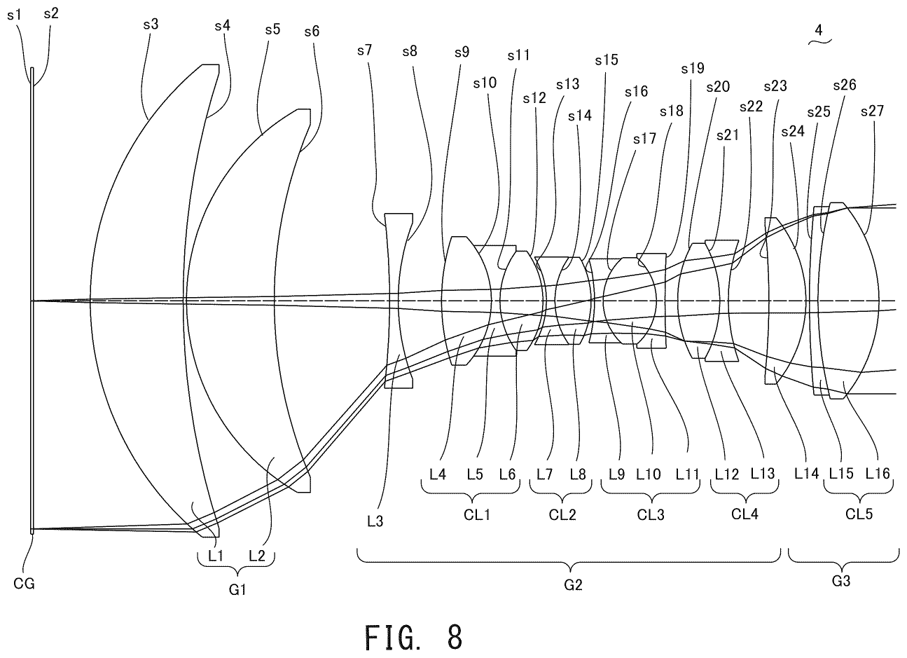

FIG. 8 is a cross-sectional view of an objective 4 according to the present embodiment. The objective 4 is a microscope objective and includes a first lens group G1 having positive refractive power, a second lens group G2 having negative refractive power, and a third lens group G3 having positive refractive power and including two lens components.

The first lens group G1 includes, in order from the object side, a lens L1 serving as a meniscus lens and having a concave surface facing the image side and a lens L2 serving as a meniscus lens and having a concave surface facing the image side. Each of the lens L1 and the lens L2 is a positive lens having positive refractive power.

The second lens group G2 includes a lens L3 serving as a biconcave lens, a cemented lens CL1, a cemented lens CL2, a cemented lens CL3, and a cemented lens CL4. The cemented lens CL1 is a three-piece cemented lens including, in order from the object side, a lens L4 serving as a biconvex lens, a lens L5 serving as a biconcave lens, and a lens L6 serving as a biconvex lens. The cemented lens CL2 is a two-piece cemented lens including, in order from the object side, a lens L7 serving as a biconcave lens and a lens L8 serving as a biconvex lens. The cemented lens CL3 is a three-piece cemented lens including, in order from the object side, a lens L9 serving as a biconcave lens, a lens L10 serving as a biconvex lens, and a lens L11 serving as a biconcave lens. The cemented lens CL4 is a two-piece cemented lens including, in order from the object side, a lens L12 serving as a biconvex lens and a lens L13 serving as a biconcave lens.

The second lens group G2 includes two or more positive lenses (the lens L4, the lens L6, and the like) and one or more negative lenses (the lens L5 and the like). The total number of lenses included in the second lens group is ten and is seven or more.

The third lens group G3 includes, in order from the object side, a lens L14 serving as a meniscus lens and having a concave surface facing the object side and a cemented lens CL5. The cemented lens CL5 is a two-piece cemented lens including, in order from the object side, a lens L15 serving as a meniscus lens and having a concave surface facing the image side and a lens L16 serving as a biconvex lens.

Various pieces of data of the objective 4 are described as follows.
fL=179.49 mm, f1=19.32 mm, f2=−1.11 mm, f3=10.38 mm
TTL=45.89 mm, ER1F=13.50 mm, ER2F=4.81 mm, ER2R=3.217 mm, ER3F=4.179 mm, v2p=45.79, v2m=40.76, n2p=1.55098, n2m=1.88815, ofb=68.17 mm, OTTL=49.44 mm

Lens data of the objective 4 is described as follows.

Objective Lens 4

| s | r | d | ne | νd | er |
|---|---|---|---|---|---|
| s1 | INF | 0.17 | 1.52626 | 54.41 | 13.25 |
| s2 | INF | 3.30 | | | 13.25 |
| s3 | 17.726 | 5.40 | 1.73234 | 54.68 | 13.43 |
| s4 | 42.808 | 0.20 | | | 12.91 |
| s5 | 12.823 | 5.10 | 1.59732 | 67.74 | 10.83 |
| s6 | 26.000 | 6.71 | | | 9.94 |
| s7 | −43.050 | 0.50 | 1.88815 | 40.76 | 4.77 |
| s8 | 12.737 | 2.52 | | | 4.24 |
| s9 | 12.101 | 2.90 | 1.59911 | 39.24 | 3.43 |
| s10 | −5.500 | 0.50 | 1.88815 | 40.76 | 2.91 |
| s11 | 4.900 | 2.50 | 1.59911 | 39.24 | 2.59 |
| s12 | −4.900 | 0.20 | | | 2.51 |
| s13 | −5.010 | 0.50 | 1.82017 | 46.62 | 2.25 |
| s14 | 4.349 | 2.10 | 1.55098 | 45.79 | 2.18 |
| s15 | −5.126 | 0.20 | | | 2.23 |
| s16 | −9.276 | 0.50 | 1.73234 | 54.68 | 2.14 |
| s17 | 3.345 | 3.10 | 1.59667 | 35.31 | 2.12 |
| s18 | −3.345 | 0.50 | 1.88815 | 40.76 | 2.21 |
| s19 | 53.981 | 0.74 | | | 2.45 |
| s20 | 6.973 | 2.45 | 1.57047 | 42.82 | 2.99 |
| s21 | −6.973 | 0.50 | 1.83945 | 42.74 | 3.04 |
| s22 | 10.441 | 2.36 | | | 3.22 |
| s23 | −41.769 | 2.15 | 1.43985 | 94.93 | 4.18 |
| s24 | −7.590 | 0.20 | | | 4.53 |
| s25 | 56.316 | 0.50 | 1.92336 | 31.60 | 5.09 |
| s26 | 23.218 | 3.55 | 1.49846 | 81.54 | 5.17 |
| s27 | −8.831 | 56.62 | | | 5.40 |

The objective 4 satisfies conditional expressions (1) to (9) as described below.

$$fL / TTL = 3.912 \qquad ( 1 )$$

$$ER 1 F / ER 2 F = 2.81 \qquad ( 2 )$$

$$ER 3 F / ER 2 R = 1.299 \qquad ( 3 )$$

$$\vert f 2 / fL \vert = 0.0062 \qquad ( 4 )$$

$$v 2 p = 45.79 \qquad ( 5 )$$

$$v 2 m = 40.76 \qquad ( 6 )$$

$$n 2 p = 1.55098 \qquad ( 7 )$$

$$n 2 m = 1.88815 \qquad ( 8 )$$

$$ofb / OTTL = 1.379 \qquad ( 9 )$$

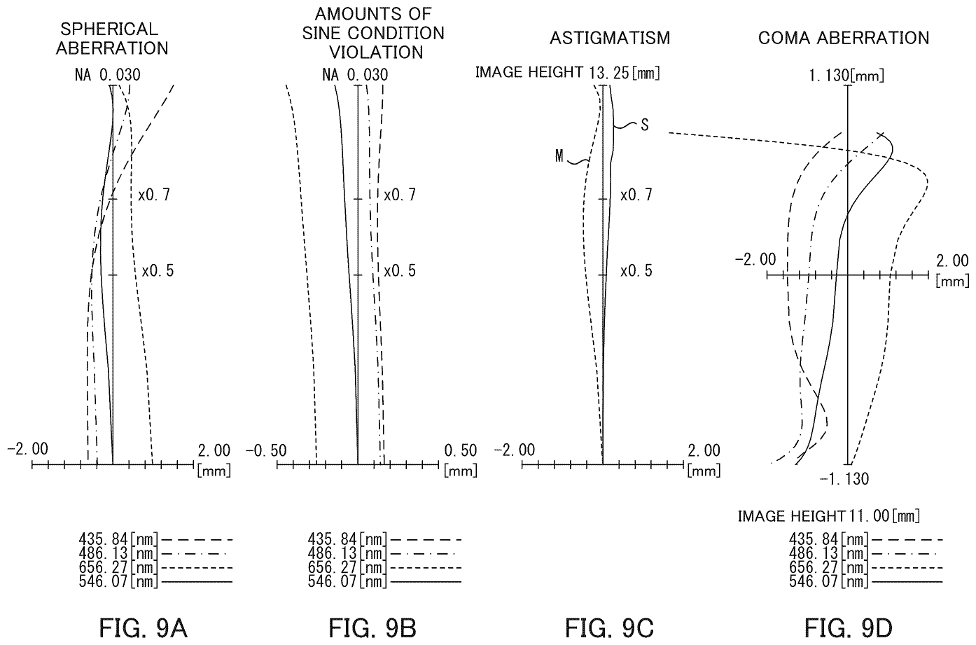

FIGS. 9A to 9D are aberration diagrams of the optical system including the objective 4 and the tube lens 10, and illustrate aberrations in the image plane obtained by performing light ray tracing from the object side to the image side. FIG. 9A is a diagram of spherical aberrations. FIG. 9B is a diagram illustrating the amounts of sine condition violation. FIG. 9C is an astigmatism diagram. FIG. 9D is a diagram illustrating coma aberrations at an image height ratio of 0.83 (image height of 11.00 mm). As illustrated in FIGS. 9A to 9D, in the present embodiment, the aberrations are satisfactorily corrected over a wide field of view.

What is claimed is:

1. An objective comprising:
a first lens group having positive refractive power;
a second lens group having negative refractive power; and
a third lens group having the positive refractive power and including two or more lens components,
the first lens group, the second lens group, and the third lens group being sequentially disposed from an object side, wherein
the first lens group includes:
a meniscus-shaped first lens having the positive refractive power, the first lens having a concave surface facing an image side; and
a meniscus-shaped second lens having the positive refractive power, the second lens having a concave surface facing the image side,
the second lens group includes two or more positive lenses and one or more negative lenses,
a total number of lenses included in the second lens group is seven or more,
the objective satisfies following conditional expressions:
$$1.6 \leq fL / TTL \leq 5 \qquad ( 1 )$$
$$2 \leq ER 1 F / ER 2 F \qquad ( 2 )$$
$$1.29 \leq ER 3 F / ER 2 R , \qquad ( 3 )$$
a surface of the second lens group, the surface being situated closest to the object side, is, among surfaces having an effective radius of ER1F/2 or less of the objective, a surface situated closest to the object side,
a surface of the third lens group, the surface being situated closest to the object side, is, among the surfaces having an effective radius of 1.29×ER2R or more of the objective, a surface situated closest to the object side, and
wherein fL is a focal length of the objective, TTL is a distance on an optical axis of the objective from a surface of the objective, the surface being situated closest to the object side, to a surface of the objective, the surface being situated closest to the image side, ER1F is an effective radius of the surface of the objective, the surface being situated closest to the object side, ER2F is an effective radius of the surface of the second lens group, the surface being situated closest to the object side, ER2R is an effective radius of a surface of the second lens group, the surface being situated closest to the image side, and ER3F is an effective radius of the surface of the third lens group, the surface being situated closest to the object side.

2. The objective according to claim 1,
wherein the objective satisfies a following conditional expression:
$$0.005 \leq \vert f 2 / fL \vert \leq 0.03 \qquad ( 4 )$$
wherein f2 is a focal length of the second lens group.

3. The objective according to claim 1,
wherein the second lens group includes three or more cemented lens components,
the objective satisfies following conditional expressions:
$$35 \leq v 2 p \qquad ( 5 )$$
$$50 \geq v 2 m \qquad ( 6 )$$
wherein v2p is a highest Abbe number with respect to a d-line among the positive lenses forming the cemented lens components included in the second lens group, and v2m is a lowest Abbe number with respect to a d-line among the negative lenses forming the cemented lens components included in the second lens group.

4. The objective according to claim 2,
wherein the second lens group includes three or more cemented lens components,
the objective satisfies following conditional expressions:
$$35 \leq v 2 p \qquad ( 5 )$$
$$50 \geq v 2 m \qquad ( 6 )$$
wherein v2p is a highest Abbe number with respect to a d-line among the positive lenses forming the cemented lens components included in the second lens group, and v2m is a lowest Abbe number with respect to a d-line among the negative lenses forming the cemented lens components included in the second lens group.

5. The objective according to claim 1,
wherein the objective satisfies following conditional expressions:
$$1.6 \geq n 2 p \qquad ( 7 )$$
$$1.85 \leq n 2 m \qquad ( 8 )$$
wherein n2p is a lowest refractive index with respect to a e-line among the positive lenses included in the second lens group, and n2m is a highest refractive index with respect to a e-line among the negative lenses included in the second lens group.

6. The objective according to claim 2,
wherein the objective satisfies following conditional expressions:
$$1.6 \geq n 2 p \qquad ( 7 )$$
$$1.85 \leq n 2 m \qquad ( 8 )$$
wherein n2p is a lowest refractive index with respect to a e-line among the positive lenses included in the second lens group, and n2m is a highest refractive index with respect to a e-line among the negative lenses included in the second lens group.

7. The objective according to claim 3,
wherein the objective satisfies following conditional expressions:
$$1.6 \geq n 2 p \qquad ( 7 )$$
$$1.85 \leq n 2 m \qquad ( 8 )$$
wherein n2p is a lowest refractive index with respect to a e-line among the positive lenses included in the second lens group, and n2m is a highest refractive index with respect to a e-line among the negative lenses included in the second lens group.

8. The objective according to claim 4,
wherein the objective satisfies following conditional expressions:
$$1.6 \geq n 2 p \qquad ( 7 )$$
$$1.85 \leq n 2 m \qquad ( 8 )$$
wherein n2p is a lowest refractive index with respect to a e-line among the positive lenses included in the second lens group, and n2m is a highest refractive index with respect to a e-line among the negative lenses included in the second lens group.

9. The objective according to claim 1,
wherein the objective satisfies a following conditional expression:
$$0.74 \leq ofb / OTTL \leq 1.41 \qquad ( 9 )$$
wherein ofb is a distance on the optical axis from an object surface to a rear focal position of the objective, and OTTL is a distance on the optical axis from the object surface to the surface of the objective, the surface being situated closest to the image side.

10. The objective according to claim 2,
wherein the objective satisfies a following conditional expression:
$$0.74 \leq ofb / OTTL \leq 1.41 \qquad ( 9 )$$
wherein ofb is a distance on the optical axis from an object surface to a rear focal position of the objective, and OTTL is a distance on the optical axis from the object surface to the surface of the objective, the surface being situated closest to the image side.
